(19) United States
(12) Patent Application Publication
(10) Pub. No.: US 2005/0266906 A1
(43) Pub. Date: Dec. 1, 2005

(54) Apparatus and method for developing a game from selectable content

(76) Inventor: Clay Stevens, Dayton, WA (US)

Correspondence Address: KUNZLER & ASSOCIATES, 8 EAST BROADWAY, SALT LAKE CITY, UT, 84111, US

(21) Appl. No.: 11/140,168

(22) Filed: May 27, 2005

Related U.S. Application Data
(60) Provisional application No. 60/574,889, filed on May 27, 2004.

(51) Int. Cl. G06F 19/00; G06F 17/00

(52) U.S. Cl. 463/1

(57) ABSTRACT

An apparatus and method are disclosed for developing a game from selectable content. In one embodiment, the apparatus includes a framework with a socket for receiving various content modules, an import module for importing content modules, a selection module for selecting a content module for association with the socket, and an association module for associating a content module with the socket. The content modules may selectably alter a game after the initial installation of the game. In addition, a reward module may reward a voucher to a user for achievement.

### CROSS-REFERENCES TO RELATED APPLICATIONS

This application is a continuation-in-part of and claims priority to U.S. Provisional Patent Application No. 60/574,889 entitled “APPARATUS, SYSTEM, AND METHOD FOR AN INTEGRATED EDUCATIONAL AND LEARNING GAMING AND CONCEPT ENGINE” and filed on May 27, 2004 for Clay Stevens, which is incorporated herein by reference.

### BACKGROUND OF THE INVENTION

1. Field of the Invention

This invention relates to games and more particularly relates to games capable of importing renewable content.

2. Description of the Related Art

Games such as board games and video games are popular recreational activities and are often used to teach educational principles. Schools often use educational games to teach subjects such as typing, spelling, mathematics, science, etc. Interesting graphics and unique user-interactions create memorable experiences for the user, increasing user interest and facilitating knowledge retention. Competitive games, such as video games, also offer emotional stimulation and strategy-based maneuvering to involve the user and provide entertainment.

Games currently available in the market, however, typically contain a limited amount of content. Consequently, the user may tire from the game as the content becomes trite. In addition, mastery of the content may be achieved, and the game must be replaced with a new game to stimulate the interest of the user. Constantly replacing games can be very costly. Furthermore, games, whether board games or video games, are generally difficult to develop and require time to produce a quality game.

To alleviate boredom from an overused game, some manufacturers provide an expansion version of a game to introduce new content to an existing game. The content, however, typically replaces the previously existing content. Consequently, the user cannot return to a previous version of the game. The user must play the game with the new content. Instead of providing more options, the expansion version simply offers alternative options.

From the foregoing discussion, it should be apparent that a need exists for an apparatus and method that enable the content of a game to be selectable and renewable without replacing the game. Beneficially, such an apparatus, system, and method would provide new and interesting content to an existing game without erasing or replacing existing content. As a result, the user would be able to select the content of the game, with the option to import new content or to select existing content.

### SUMMARY OF THE INVENTION

The present invention has been developed in response to the present state of the art, and in particular, in response to the problems and needs in the art that have not yet been fully solved by currently available games. Accordingly, the present invention has been developed to provide an apparatus, system, and method for developing a game from selectable content that overcome many or all of the above-discussed shortcomings in the art.

The apparatus to develop a game from selectable content is provided with a logic unit containing a plurality of modules configured to functionally execute the necessary steps of importing content modules, selecting a content module for association with a socket, and associating a content module with a socket. These modules in the described embodiments include an import module, a selection module, and an association module.

The apparatus, in one embodiment, is configured to import content modules to increase the content selection of a game. The apparatus may include a framework having a socket for receiving various content modules, an import module for importing content modules, a selection module for selecting a content module for association with the socket, and an association module for associating a content module with the socket. Thus, the user may select the content for a game.

The apparatus is further configured, in one embodiment, to reward a user with a voucher for achievement. The voucher may provide a discount for a product or service. Consequently, a reward-enabled game may be used for product promotion in certain embodiments.

In a further embodiment, the apparatus may be configured to generate a printable version of a game. The user may choose to print a copy of a game and corresponding game pieces developed from selected content. The user may be able to develop and print a board game, puzzle, or the like patterned after an electronic game in certain embodiments.

A method of the present invention is also presented for developing a game from selectable content. The method in the disclosed embodiments substantially includes the steps necessary to carry out the functions presented above with respect to the operation of the described apparatus and system. In one embodiment, the method includes providing a framework having a socket for receiving various content modules, importing at least one content module, selecting a content module for association with the socket, and associating a content module with the socket. The method also may include rewarding a voucher to a user for achievement, customizing the game according to a user selection, and contracting with a third party to customize the game with data particular to the third party.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention provides selectable and renewable content to an existing game without replacing the game or its content. Consequently, the user can select the content to develop a game including game content available in an initial installation. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a game engine of the present invention for developing a game from selectable content;

FIG. 2 is a screenshot illustrating one embodiment of a file hierarchy of a game engine in accordance with the present invention;

FIG. 3 is a screenshot illustrating another embodiment of a file hierarchy of a game engine in accordance with the present invention;

FIG. 4 is a schematic flow chart diagram illustrating one embodiment of a game development method of the present invention;

FIG. 5 is a schematic flow chart diagram illustrating one embodiment of a game implementation in accordance with the present invention;

FIG. 6 is a screenshot illustrating one embodiment of a word puzzle game with user input trackers in accordance with the present invention;

FIG. 7 is a screenshot illustrating one embodiment of a dialog box enabling user selection in accordance with the present invention;

FIGS. 8A-8B are screenshots illustrating one embodiment of an agriculture game in accordance with the present invention;

FIG. 9A is a screenshot illustrating one embodiment of third party personal data integrated into a game in accordance with the present invention;

FIG. 9B is a screenshot illustrating another embodiment of third party personal data integrated into a game in accordance with the present invention;

FIG. 10 is a screenshot illustrating one embodiment of a reward voucher of the present invention;

FIG. 11 is a screenshot illustrating one embodiment of a game in accordance with the present invention;

FIG. 12 is a schematic flowchart diagram illustrating one embodiment of a game engine of the present invention; and

FIG. 13 is a schematic flow chart diagram illustrating one embodiment of a game customized for agricultural education in accordance with the present invention.

### DETAILED DESCRIPTION OF THE INVENTION

Many of the functional units described in this specification have been labeled as modules, in order to more particularly emphasize their implementation independence. Modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

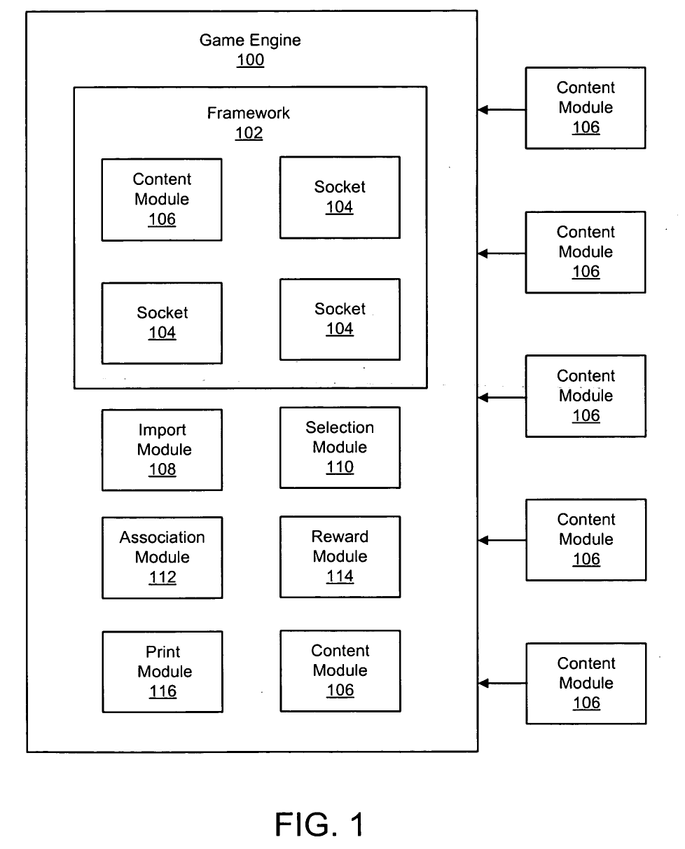

FIG. 1 depicts a game engine 100 in accordance with the present invention. The game engine 100 may include a framework 102 with one or more sockets 104, a plurality of content modules 106, an import module 108, a selection module 110, an association module 112, a reward module 114, and a print module 116. The game engine 100 enables customization of a game by associating various content modules 106 with one or more sockets 104. The socket 104 may be a folder in certain embodiments. The content modules 106 may be internal or external to the framework 102 and preferably do not replace existing content modules 106, operating and data files, or the like. Original content is preserved such that the game engine 100 may selectively integrate the content from old and new content modules 106 into a game without necessarily replacing an original version.

Several games may be created from one game engine 100. A game may comprise a physical game or a digital game. In certain embodiments, the game engine 100 creates physical and digital games such as: “how it works” simulations, exploration games, business simulators, network marketing simulators, service-provider simulators, electronic versions of board games, instructional time-lines, word puzzles, drag and drop race games, discovery type games, jigsaw puzzles, faith-promoting games, transformational games, manufacturing games, and educational games. The framework 102 may provide a basic, predictable game structure, while the various content modules 106 enable varying game content. The content of a game may be selectably altered after the initial installation of the game engine 100. Thus, content modules 106 with updated material or different thematic variations and the like may be added to the game engine 100 without installing a new game.

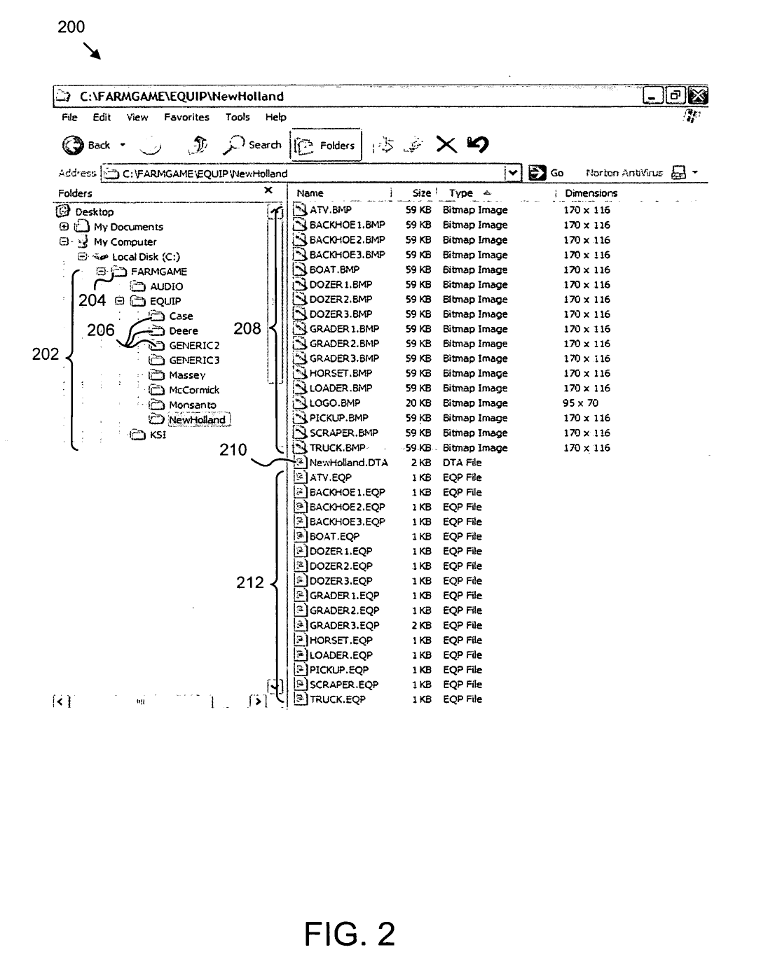

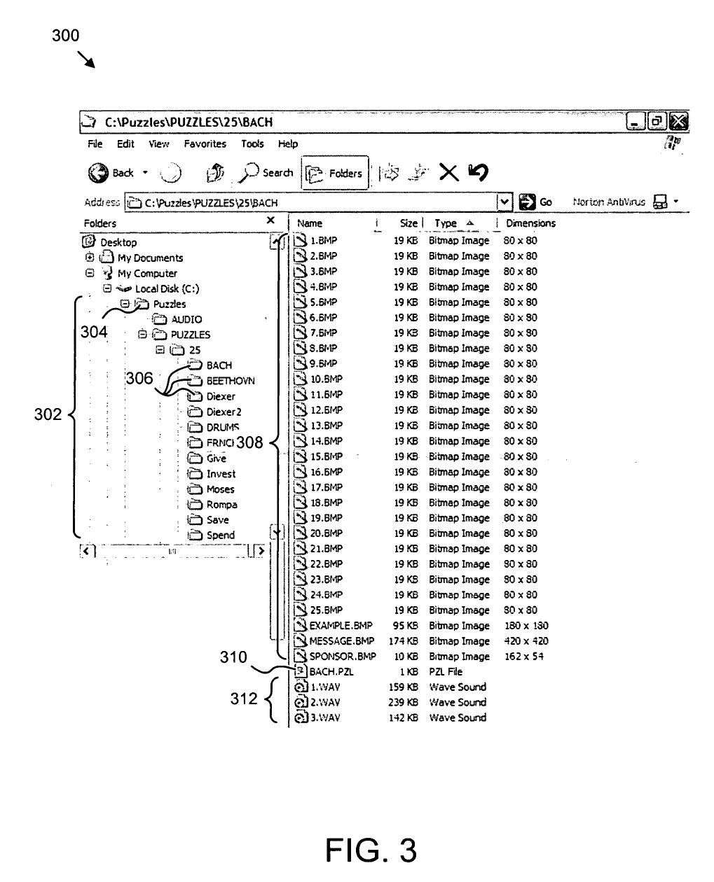

FIGS. 2 and 3 illustrate various embodiments of a file hierarchy of a game engine in accordance with the present invention. Referring now to FIG. 2, a file tree 200 contains file folders 202 for a game depicted as FARMGAME. The main folder 204 contains the majority of the framework 102 for the game and may contain sockets 104 to receive a variety of game content from content modules 206. As illustrated, a content module 206 may contain various files such as graphic files 208, algorithm data 210, and data files 212. In certain embodiments, audio files maybe stored in a separate by linked folder. Different content modules 206 maybe selected to develop unique games of varying content. In the depicted embodiment, the content modules 206 vary according to a manufacturer of farming equipment and have corresponding content files 208, 210, 212 to illustrate products and services available from the selected manufacturer.

FIG. 3 illustrates a file tree 300 for a puzzle game. The file tree 300 similarly contains file folders 302, a main folder 304, and various content modules 306. The content modules 306, in one embodiment, contain content to create various puzzles, which may be printable in certain embodiments. As illustrated, the content modules 306 may contain graphic files 308, algorithm data 310, and audio files 312. In a further embodiment, the algorithm data 310 may comprise data for a unique reward voucher. Each content module 306 contains sufficient information to create a separate game, or in other words, a game with unique operating parameters, graphics, game environments and the like. A basic game engine 100, in certain embodiments, may be used to develop an infinite number of games from varying content modules 206.

In certain embodiments, the content modules 306 contain information to selectably alter characteristics of the game in order to showcase a specific brand name. Consequently, a game may be customized to train a user for a specific product or for use as an advertisement to introduce users to a product or service.

In addition, content modules 306 may be compiled by anyone who has an interest in customizing a game. For example, the user may be able to customize the content to reflect an organization or a personal interest. The manufacturer of the game engine 100 may desire to offer interesting changes to operating conditions. In one embodiment, the content modules 306 contain customization data particular to a third party customer. Consequently, the third party may be contracted to provide customized data particular to the third party. In an alternative embodiment, the content modules 306 may be customized to contain updated educational material directed to a student, which may provide an educator with options to update study materials.

The content modules 306 may be digital files capable of being transferred through a network such as the Internet or the like. In certain embodiments, the content modules 306 contain content such as data files, objects, rules, parameters, conditions, reward codes, data sets, graphics, media files, audio files, and video files. In one embodiment, a user downloads various content modules 306 from a website. Alternatively, various content modules 306 maybe emailed directly to a subscriber. Those of skill in the art will recognize that content modules 306 may be made available to a user through various methods.

Referring to FIG. 1, the import module 108 may import various content modules 106 to supplement the content of the game engine 100. The selection module 110 may select a particular content module 106 for association with a socket 104. A selection may be activated by a user. Alternatively, other limitations may determine a selection. The association module 112 associates a selected content module 106 with an appropriate socket 104. Certain associations may occur automatically.

The reward module 110 issues a reward to a user, such as a voucher for a discounted product or service, when a user demonstrates a certain level of achievement. Examples of achievement may include completing a puzzle, demonstrating mastery of a skill, passing a level of a game, or the like. In certain embodiments, the voucher comprises a unique code that issues only once for a certain achievement. In addition, the user may be required to perform an additional action in order to redeem or actuate a voucher. For example, the user may be required to call a 1-800 number and/or visit a website to request the voucher and/or to redeem the voucher. A reward code may be required to redeem a prize. In certain embodiments, the voucher, coupon, and/or the product may be mailed to the user. Alternatively, the user may be able to print a voucher or coupon directly.

The print module 116 may enable the user to print a reward voucher. In addition, the print module 116 may enable generation of a printed version of a game. In certain embodiments, content modules 106 may be used to customize a game for printing. As a result, the user may print games such as board games, puzzles, game pieces, cards, and the like. In certain embodiments, a customized electronic game may be played on a computer as well as printed for hands-on interaction.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

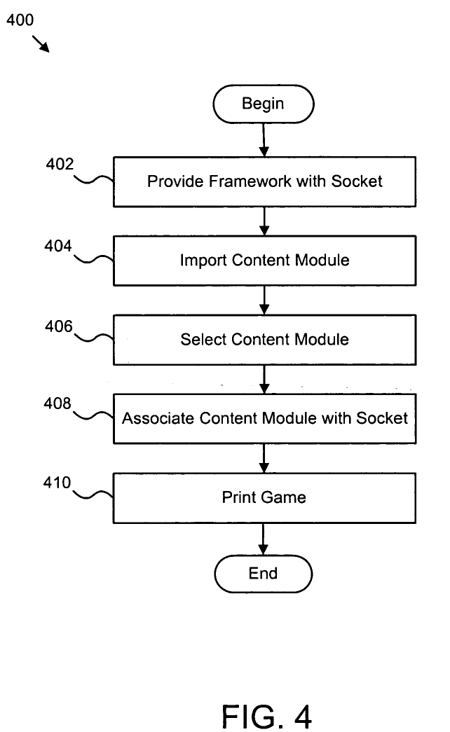

FIG. 4 illustrates one embodiment of a game development method 400 of the present invention. As depicted, the game development method 400 includes the steps of providing 402 a framework 102 with sockets 104, importing 404 content modules 106, selecting 406 a content module, associating 408 a content module 106 with a socket 104, and printing 410 a game. The game development method 400 enables production of a game from a basic framework 102. The game development method 400 may or may not include all of the illustrated steps. Additional steps may also enhance the overall game development method 400.

In one embodiment, the import module 108 imports 404 one or more content modules 106. The framework 102 may include provisions to display the content modules 106 to the user for user selection. The user, in conjunction with the selection module 110 may select 406 a desired content module 106. Subsequently, the association module 112 may associate 408, or “plug-in,” the content module 106 with a corresponding socket 104. The content in the content module 106 may subsequently be integrated with the framework 102 of the game engine 100, thereby enabling creating a game. In certain embodiments, the game development method 400 renews or updates the currently available content without replacing existing files.

In certain embodiments, the game development method 400 may further include rewarding a voucher to a user, customizing the game, and contracting with a third party to customize the game with data particular to the third party. Thus, the game may be customized to advertise merchandise and/or services provided by the third party.

As mentioned, the print module 114 may generate a printable version of a game. A game may be printed 410 to include game tokens, spinners, cards, and the like. Users may play a physical version of an electronic game if desired.

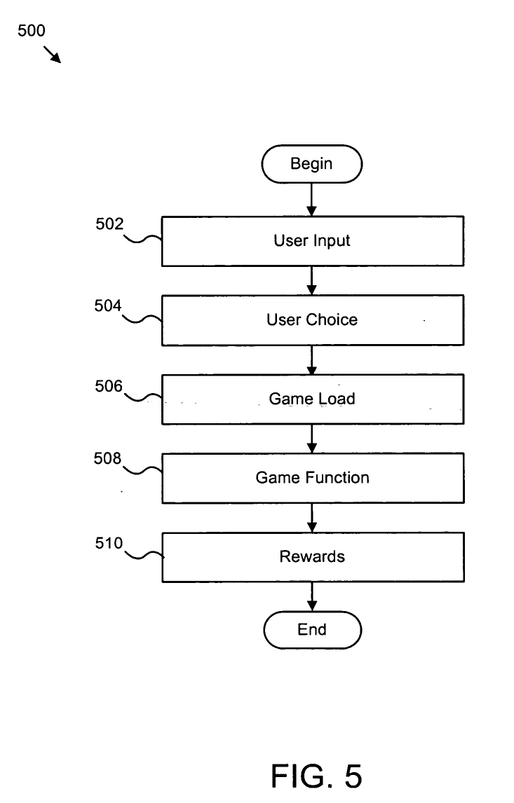

FIG. 5 illustrates one embodiment of a game 500. The game 500 may include user input 502, user choice 504, a game load 506, game function 508, and rewards 510. The game 500 may function in conjunction with content provided from a content module 106. A voucher may be awarded to a user as described above in order to promote a product and/or service.

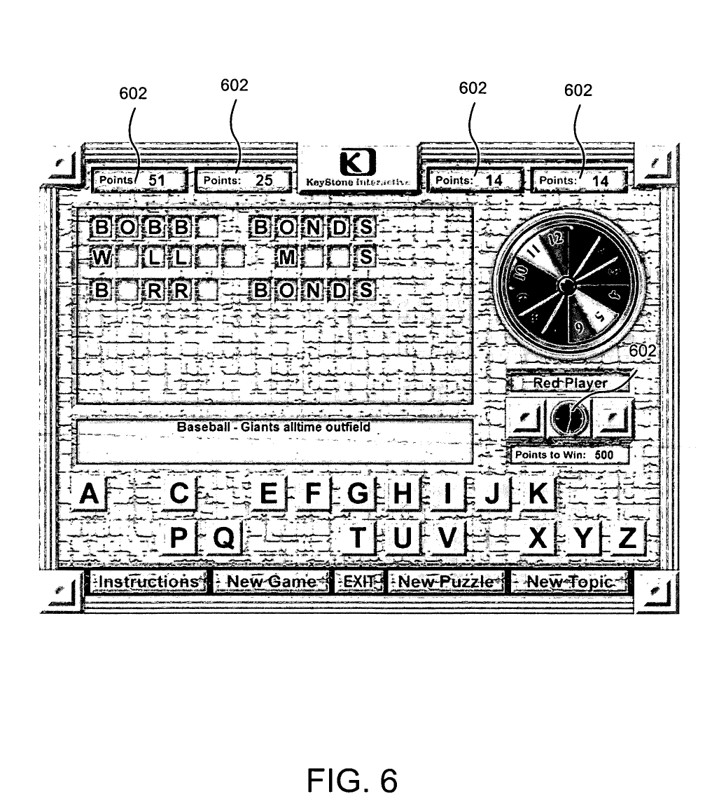

FIGS. 6-11 illustrate screenshots from various embodiments of an electronic computer game created by a game engine such as the game engine 100. FIG. 6 illustrates one embodiment of a puzzle using user input. Each player enters their name and chooses a marker for game play. The game tracks the players' position, score, success level, and current situation against the game success criteria, turn time, and etc. The color trackers 602 may function responsive to the user input, such as the login name or the game marker/token chosen at the beginning of the game.

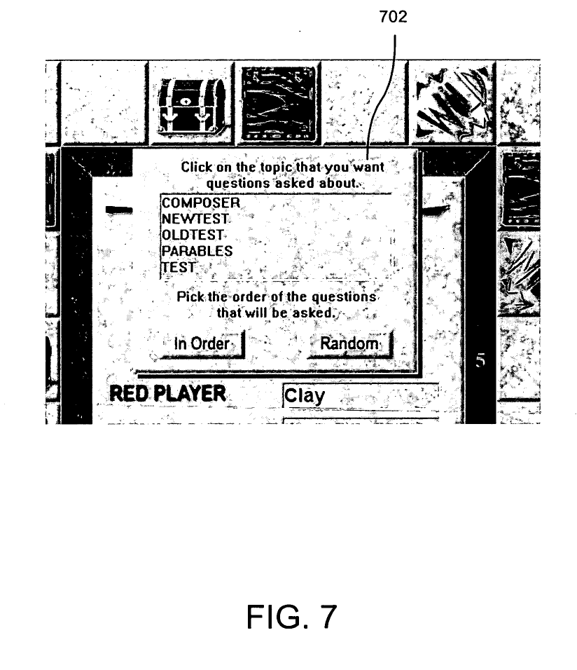

FIG. 7 illustrates a background screen with a dialog box 702 that enables a user to choose a game set for the game. The game set may comprise a game resulting from integration of a particular content module 106. The resulting game may consist of a unique graphic display, audio files, and game algorithm data load. The data load may include, but is not limited to: questions, end game conditions, game variable data for business simulations such as expense to revenue ratios, interest rates, means of production, costs & paybacks, and network group configurations with bonus structure.

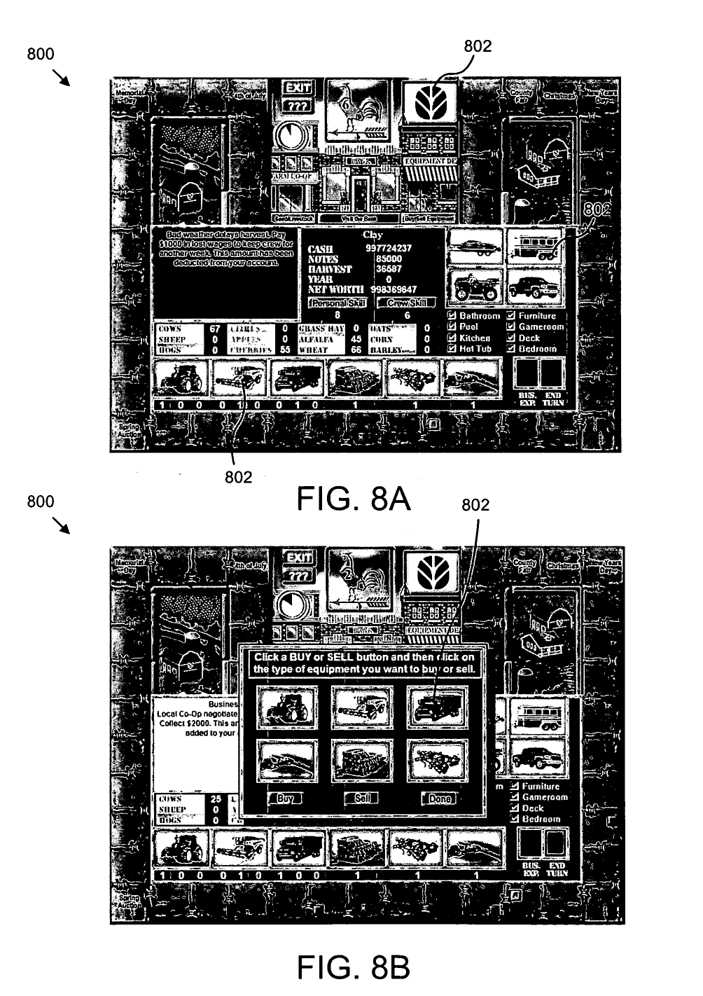

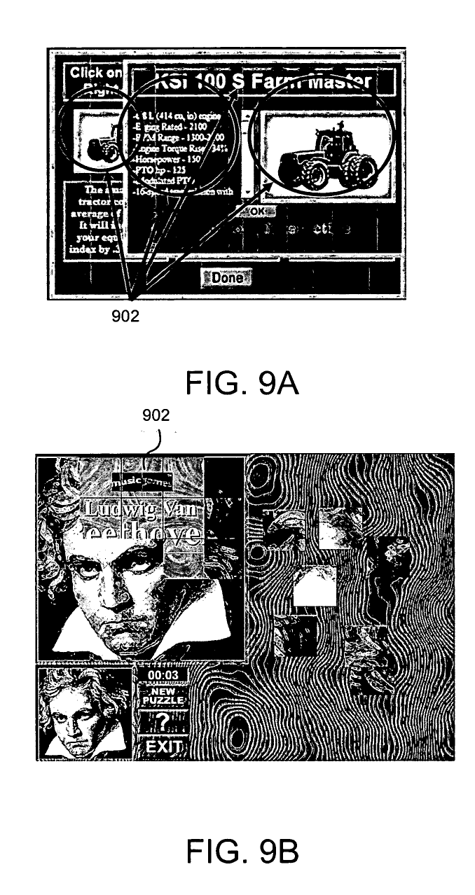

FIGS. 8A-8B illustrate one embodiment of a loaded agriculture game 800. Game loads data may be contained in external files. The external files may consist of graphics, audio, game data, feedback text, and variable data for game algorithms such as: economic data, questions for players at specific levels or topics chosen at login, starting conditions, end game conditions, success definition, rewards enabled, turn time, and game object functionality. Customized content 802 may represent a particular third party. The depicted screenshots may represent a business simulation game. FIGS. 9A-9B illustrate additional examples of customized content 902.

Game Function data populates variables for use during game play and provides graphic display, user prompts, feedback, regulate game function via computational algorithms, sets success conditions, rewards for varying levels of success, and end game. Game function data may be included in the framework 102 and may further be included in content modules 106.

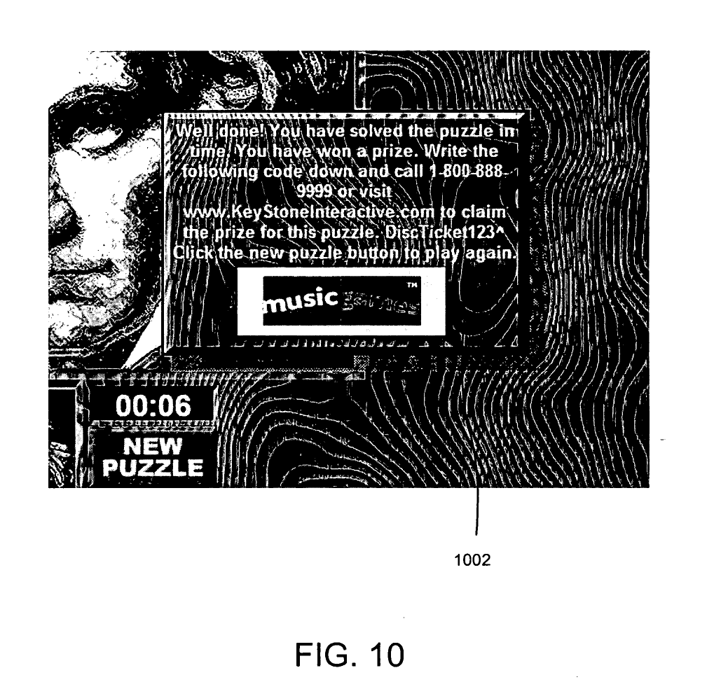

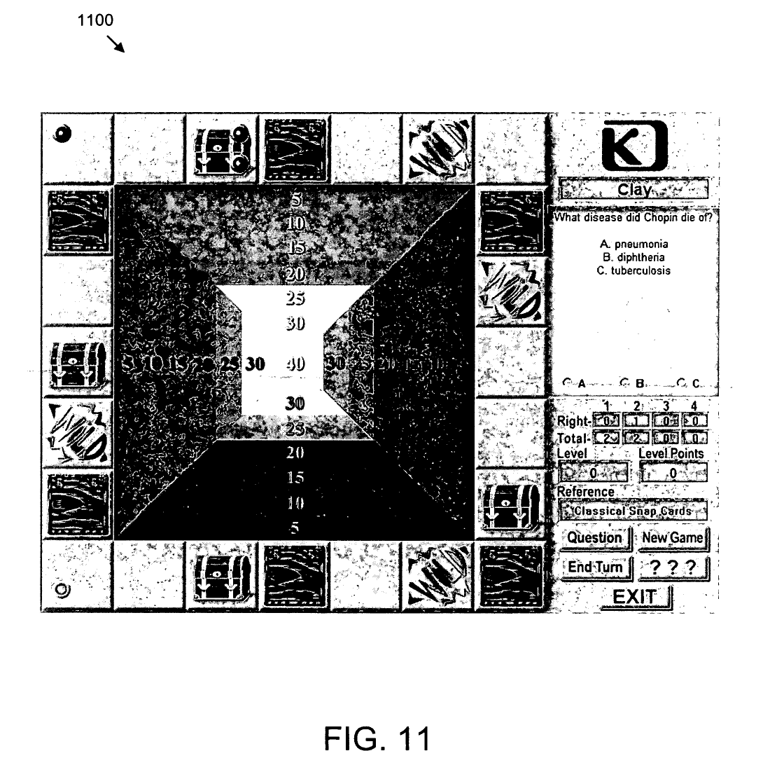

FIG. 10 illustrates one embodiment of a reward 1002. If a player satisfies the success condition(s) of the game, the player may receive a reward code. This code may be redeemable for products or services or discounts on products or services of a sponsoring company. FIG. 11 illustrates another embodiment of a game 1100 developed from a game engine 100. A game engine 100 may be configured to develop games 1100 having a similar format.

In one embodiment, the game engine 100 develops a game in a predictable manner. The following outline illustrates one example of a predictable, dynamic game scenario that enables background graphics, texts, auditory elements, and the like to be altered by importing one or more content modules 106 in order to up-date or “renew” the content of the game.

Game Setup

1. Game environment is a metaphor for players to move around the “world”;
2. Comprises a random number generator—spinner, dice, or etc.;
3. Player pawns represent the location of individual players at any given moment in time;
4. Marked by seasons or the passing of time in yearly cycles or business cycles;
5. Login capability to identify each player by color or name or specific player pawn;
6. Capability to load saved game;
7. Enables access to instructions.
   Game Play
1. Generates a random number;
2. Lets players move their pawn around the environment following the game track in either direction;
3. Lets players borrow resources from a lending source, such as a bank, friend, or other resource repository necessary for game play;
4. Lets players repay borrowed resources with interest;
5. Lets players buy means of production or barter/trade or otherwise acquire necessary items to play game. This could be land, equipment, team members, out-buildings, livestock, house, pick-up;
6. Includes a mechanism for calculating income & expenses;
7. Allows random events to occur involving such aspects as: weather, economy, government, crew, equipment, family;
8. Has consequences for each location in the game environment;
9. Has a method for keeping track of each player's resources: cash, debt, item ownership, etc.;
10. Has stated rules for playing, buying or selling items, borrowing money, repayment logistics, interest, starting conditions: money, items owned, speculating on farm futures, or running a breeding farm;
11. Has a methodology for transactional dynamics: how do items effect income, how much does each item cost, does age affect item, livestock breeding algorithm, income algorithm from items owned and random events, expenses due to operations and random events;
12. Has a mechanism so that players can end their turns;
13. Has a mechanism and algorithm for handling exceeding game resource borrowing limit, such as bankruptcy.
   Ending the Game
1. Includes a mechanism for ending the game;
2. Has a way to save a game;
3. Has a way to exit without saving the game;
4. Has a method for ending the game or notifying players that their “end-game” criteria has been met as a matter of rule: time, cash, years played, net worth or some other mechanism.
   Graphical Interface/Locations
1. Squares/game track, buttons, pop-up windows, instructions, log-in, farms, equipment, livestock, out-buildings;
2. Picturesque game center with graphics such as a farming theme.
   Architecture
1. No more than 4 players;
2. Must be delivered to the Windows platform, via CD-ROM package;
3. Must be compatible with Windows XP, Windows NT, Windows 98, and Windows 95 operating systems;
4. Must call audio files must be from external files;
5. Must have the ability to “up-load” new business scenarios based on ASCII text files distributed from multiple sources such as the internet, intranet, email or other distribution mechanisms.

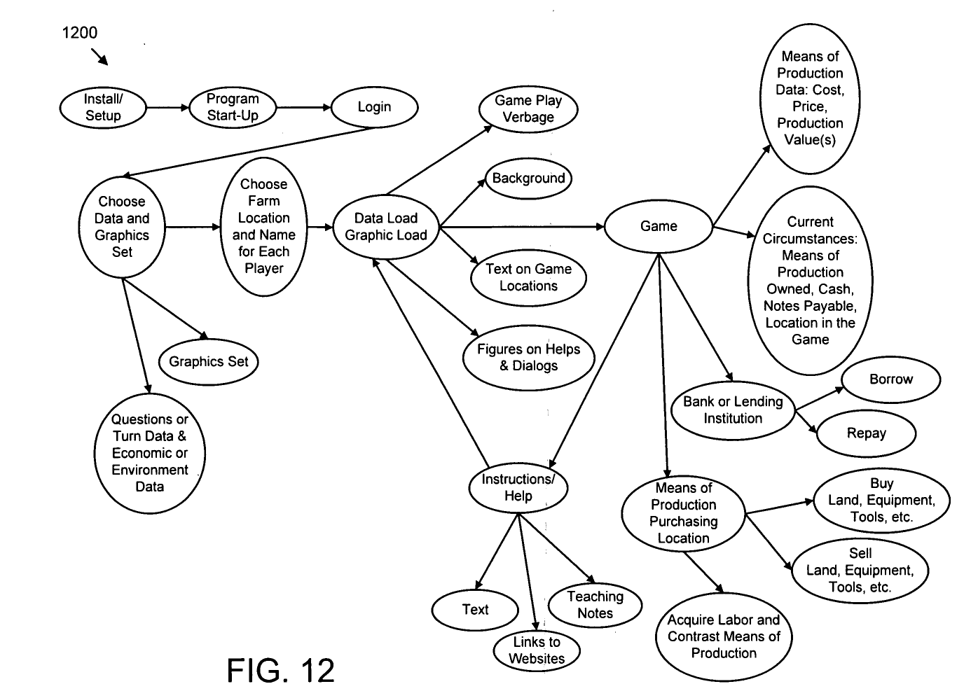

FIG. 12 illustrates one embodiment of a generic game engine map 1200. The generic game engine map 1200 illustrates the navigational elements for moving around an environment, getting information about each of the players' current circumstances, and obtaining information about the means of production or concepts of a game environment. Game navigation includes such features as exiting the program, ending turns, gathering data and information about current circumstances, buying, and means of production, etc.

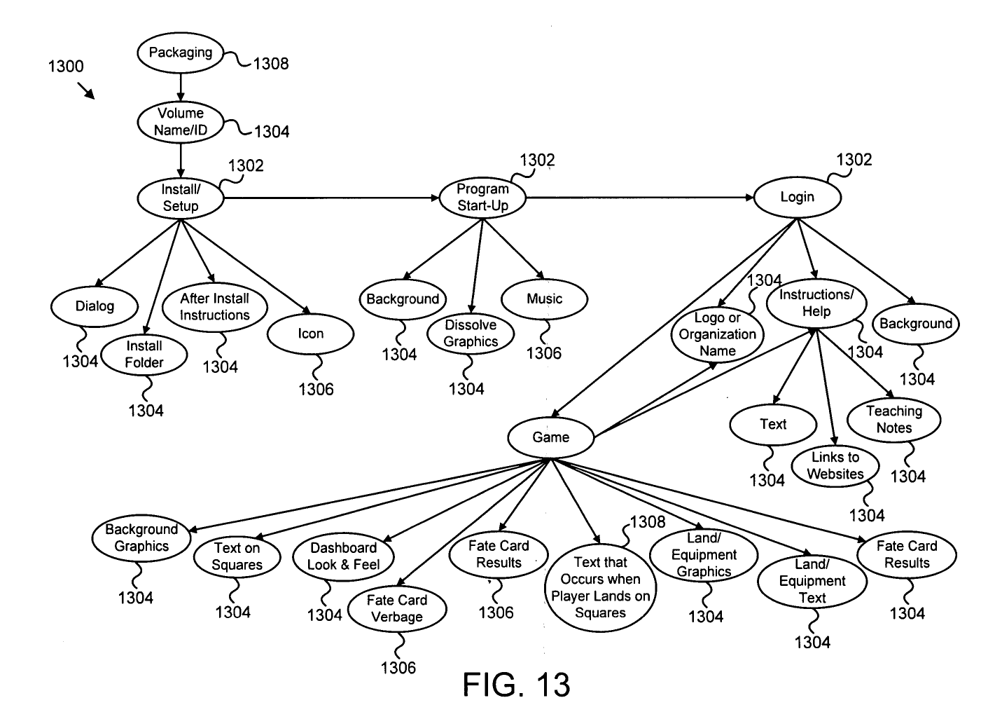

FIG. 13 illustrates one embodiment of a more detailed game engine map 1300. The game engine map 1300 may correspond to an agricultural game based on a product-based business set-up, such as the game illustrated in FIGS. 8A-8B. The circles labeled 1302 illustrate characteristics of the game that can be modified easily with a file replacement. Circles labeled 1304 represent characteristics requiring internal game modifications that typically require additional time to develop. Circles labeled 1306 represent characteristics that can be altered by a file exchange. And circles labeled 1308 represent characteristics that simply require downloading, or characteristic a user can change by creating their own files.

The music or audio files in the path Packaging|Volume Name/I.D.| Install/Setup|Program Start-Up|Music may be kept in a separate but linked folder. This allows the files to be exchanged or replaced either by downloading files from another source such as the internet or a CD. Additionally, the game author or distributor can effectively change the game's aural sense, environment, and game localization by simply exchanging files.

The audio files can be used for positive and negative audio feedback to enhance the player's gaming experience and reinforce learning objectives; game instructions, including introductions, coaching prompting, and context-specific help such as “what do I do now?”; navigation aids, such as sounds to notify players that they clicked on a button or game location; game-over or bonus play sounds, and miscellaneous musical elements.

The game engine 1300 may use information from imported ASCII text files to run the macro and micro algorithms, such as economics, the cost or means of production, the pay-outs for various sales of products or services, cost of goods sold, sale of means of production if necessary, banking rules and other features of business content games. The game engine also may use ASCII text files in concept teaching games to import question sets and criteria for game play such as question order and event results. Furthermore, ASCII text files may be used to generate reward codes and/or vouchers for achievement.

All of the text and data that pertain to cost, sale value and means of production specification/capability may come from external text/data files. The game engine 1300 may import these files on the fly as the players request the data.

The game engine 1300 also may load game graphics from external files. The game engine 1300 may use the information from ASCII text files to load a specific look and feel. As a result, a player may upgrade a game to use current economic information. For example, a player may choose to load 2004 economic data into a game that was previously using 2002 economic data. If the game were an agriculture game, the game may typically use currently available tractors, loaders, trucks, and other means of production along with the appropriate graphics for the period. Conversely, if a player wanted to use 1924 economic data, the player may be able load 1924 economic data to work with equipment available in 1924 and experience economic situations prevalent in 1924.

Multiple game engines and game engine designs maybe developed that allow for renewing of data to regulate game algorithms, graphic sets, audio, text messages, questions with answers and results, and the like. Specific examples may include, but are not limited to, the selected embodiments listed below:
1. Product business simulation engine—Agriculture Game. Imports graphic sets for logos, equipment, and personal use items, text files for equipment, land & livestock, and data for economics (prime rate, equipment costs/efficacy, land & livestock costs/payouts, personal skill levels . . . (152 different game parameters) and starting circumstances for players. Could be from baseline(scratch) or in the middle of the game (2 tractors, 1 combine, 1 truck, $25 K cash, $50 K bank note, . . . Audio files for sounds, messages, and et cetera are generic and can be replaced if new file uses same .wav file name.
   Secondary sales into established market
   a. Game wizard—allows user community (teacher, player, curriculum developer, private labeler, KSI . . . ) to create new economic conditions for the game: costs, prices, payouts, efficiency, interest rates, expense and revenue ratios, insurance and tax rates, how much time a player has to take their turn . . .
   b. Scenario Builder—allows user community (teacher, player, curriculum developer, private labeler, KSI . . . ) to create new business conditions: equipment, land, livestock types and amounts owned. time played (years), personal/crew farming skill, time of year to begin play, personal items owned: ATV, Boat, Deck, Game Room . . . , cash, bank notes, and et cetera.
   c. Game sets—graphic sets with economic data to a period depicted in the graphic sets 1924 equipment, 1924 economic data
   a. Scenarios—A starting place for players with specific conditions. Can be combined with game set to create a realistic unlimited problem solving environment.
   b. Curriculum materials—1,000 classroom ready lesson plans in 13 different subject areas: Business, Agri-Business, Economics, Accounting, Math, Science, English, Social Studies, Political Science, Careers, Technology, Geography, Environmental Education.
2. Service business simulation engine—Contractor Game. Imports graphic sets for logos, equipment, and personal use items, text files for equipment, and data for economics (prime rate, equipment costs/efficacy/payouts, personal skill levels . . . (152 different game parameters) and starting circumstances for players. Could be from baseline(scratch) or in the middle of the game somewhere (2 backhoes, 1 dozer, 1 truck, $25 K cash, $50 K bank note, . . . Audio files for sounds, messages, and et cetera are generic and can be replaced if new file uses same .wav file name.
   Secondary sales into established market
   a. Game wizard—allows user community (teacher, player, curriculum developer, private labeler, KSI . . . ) to create new economic conditions for the game: costs, prices, payouts, efficiency, interest rates, expense and revenue ratios, insurance and tax rates, how much time a player has to take their turn . . .
   b. Scenario Builder—allows user community (teacher, player, curriculum developer, private labeler, KSI . . . ) to create new business conditions: equipment, types and amounts owned. time played (years), personal/crew contracting skill, time of year to begin play, personal items owned: ATV, Boat, Deck, Game Room . . . , cash, bank notes, and et cetera.
   c. Game sets—graphic sets with economic data to a period depicted in the graphic sets 1924 equipment, 1924 economic data
   d. Scenarios—A starting place for players with specific conditions. Can be combined with game set to create a realistic unlimited problem solving environment.
   e. Curriculum materials—1,000 classroom ready lesson plans in 13 different subject areas: Business, Agri-Business, Economics, Accounting, Math, Science, English, Social Studies, Political Science, Careers, Technology, Geography, Environmental Education
3. Q&A game engine—Bible Quest, Risk & Reward, and Summit import questions, answers, and references from ASCII text files players choose at the beginning of game. Uses audio pointers for music and reference data (scriptures . . . )
   Secondary sales into established market
   a. Game wizard—allows user community (teacher, player, curriculum developer, private labeler, KSI . . . ) to create new question sets for the game. The output from this tool is an ASCII text file that can be shared or sold to organizational members or the community at large.
   b. Game Sets—A set of pre-made questions on various topics that can be distributed as fee or subscription based download to replenish the original game. Great for fund raisers, revenue generation, gifts, message delivery or sponsorship.
   c. Curriculum materials—Thousands of home and classroom ready lessons and activities for study in any subject area including: religion, transformational training, and the K-12 public school setting.
4. Quadro—Battleship style discovery game. Find 4 pictures of three different subjects in a row. Graphics and questions are imported when game starts. Pictures are shuffled for each game.
   Secondary sales into established market
   a. Game wizard—allows user community (teacher, player, curriculum developer, private labeler, KSI . . . ) to create new question and graphic sets for the game. The game can use existing graphic sets or the author can create their own sets. Game sets can be shared or sold to organizational members or the community at large.
   b. Game Sets—A set of pre-made graphics and related questions on various topics that can be distributed as fee or subscription based download to replenish the original game. Great for fund raisers, revenue generation, gifts, message delivery or sponsorship.
   c. Curriculum materials—Thousands of home and classroom ready lessons and activities for study in any subject area including: religion, transformational training, and the K-12 public school setting.
5. Spin & Spell—Regenerate phrases to solve in any subject area. Phrases come from ASCII text files. Files can be shared or sold.
   Secondary sales into established market
   a. Game wizard—allows user community (teacher, player, curriculum developer, private labeler, KSI . . . ) to create new topical phrase sets for the game. The output from this tool is an ASCII text file that can be shared or sold to organizational members or the community at large.
   b. Game Sets—A set of pre-made topical phrase sets on various topics that can be distributed as fee or subscription based download to replenish the original game. Great for fund raisers, revenue generation, gifts, message delivery or sponsorship.
   c. Curriculum materials—Thousands of home and classroom ready lessons and activities for study in any subject area including: religion, transformational training, and the K-12 public school setting.
6. Concentration—16 & 36 piece hide and seek game with renewable graphics and audio sets.
   Secondary sales into established market
   a. Game wizard—allows user community (teacher, player, curriculum developer, private labeler, KSI . . . ) to create new game sets of graphics and audio files for the game. Game sets can be shared or sold to organizational members or the community at large.
   b. Game Sets—A set of pre-made game sets on various topics that can be distributed as fee or subscription based download to replenish the original game. Great for fund raisers, revenue generation, gifts, message delivery or sponsorship.
   c. Curriculum materials—Thousands of home and classroom ready lessons and activities for study in any subject area including: religion, transformational training, and the K-12 public school setting.
7. JigSaw Puzzle—25 & 49 piece drag & drop puzzles—Renewable graphics & audio sets
   Secondary sales into established market
   a. Game wizard—allows user community (teacher, player, curriculum developer, private labeler, KSI . . . ) to create new topical puzzle graphic sets for the game. The puzzles can be shared or sold to organizational members or the community at large.
   b. Game Sets—A set of pre-made puzzles on various topics that can be distributed as fee or subscription based download to replenish the original game. Great for fund raisers, revenue generation, gifts, message delivery or sponsorship.
   c. Curriculum materials—Thousands of home and classroom ready lessons and activities for study in any subject area including: religion, transformational training, and the K-12 public school setting.
8. Point to Point Path Simulation—Chutes and Ladders type game—Players move along a path from the start of the game to its end point. Players answer questions from a renewable question database. Reloadable questions, graphics & audio sets
   Secondary sales into established market
   a. Game wizard—allows user community (teacher, player, curriculum developer, private labeler, KSI . . . ) to create new topical questions along with graphic sets for the game. The games can be shared or sold to organizational members or the community at large.
   b. Game Sets—A set of pre-written questions and answers with context references on various topics that can be distributed as fee or subscription based download to replenish the original game. Great for fund raisers, revenue generation, gifts, message delivery or sponsorship.
   c. Curriculum materials—Thousands of home and classroom ready lessons and activities for study in any subject area including: religion, transformational training, and the K-12 public school setting.
9. Design for Network Marketing game engine—Residual Income Game. Imports graphic sets, text files, audio files for sounds, messages, and et cetera are generic and can be replaced if new file uses same .wav file name.
10. Design for Money Management/Budgeting game engine—Game that teaches financial responsibilities, including, budgeting, spending and buying habits, financial planning, end of month reconciliation. Imports graphic sets, text files, audio files for sounds, messages, and et cetera are generic and can be replaced if new file uses same .wav file name.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for developing a game from selectable content, the apparatus comprising:
a framework having a socket for receiving various content modules, wherein the content modules are configured to selectably alter a game after the initial installation of the game;
an import module configured to import content modules;
a selection module configured to select a content module for association with the socket; and
an association module configured to associate a content module with the socket.

2. The apparatus of claim 1, further comprising a reward module configured to enable a game to reward a voucher to a user for achievement.

3. The apparatus of claim 2, wherein the voucher comprises a discount for a product.

4. The apparatus of claim 2, wherein the voucher comprises a discount for a service.

5. The apparatus of claim 1, wherein the socket comprises a folder.

6. The apparatus of claim 1, wherein content modules are selected from the group consisting of data files, objects, rules, parameters, conditions, data sets, graphics, media files, audio files, and video files.

7. The apparatus of claim 1, wherein a game is selected from the group consisting of “how it works” simulations, exploration games, business simulators, network marketing simulators, service-provider simulators, electronic versions of board games, instructional time-lines, word puzzles, drag and drop race games, discovery type games, jigsaw puzzles, faith-promoting games, transformational games, manufacturing games, and educational games.

8. The apparatus of claim 1, further comprising a print module configured to generate a printable version of a game.

9. The apparatus of claim 7, wherein the print module is further configured to generate a printable voucher for achievement.

10. A method for developing a game from selectable content, the method comprising:
providing a framework having a socket for receiving various content modules, wherein the content modules are configured to selectably alter a game after the initial installation of the game;
importing at least one content module;
selecting a content module for association with the socket; and
associating a content module with the socket.

11. The method of claim 10, wherein the method further comprises rewarding a voucher to a user for achievement.

12. The method of claim 10, further comprising customizing the game according to a user selection.

13. The method of claim 10, further comprising contracting with a third party to customize the game with data particular to the third party.

14. The method of claim 10, wherein the content modules contain customization data particular to a third party customer.

15. A signal bearing medium tangibly embodying a program of machine-readable instructions executable by a digital processing apparatus to perform an operation to developing a game from selectable content, the operation comprising:
providing a framework having a socket for receiving various content modules, wherein the content modules are configured to selectably alter a game after the initial installation of the game;
importing at least one content module;
selecting a content module for association with the socket; and
associating a content module with the socket.

16. The signal bearing medium of claim 15, wherein the instructions further comprise an operation to reward a voucher to a user for achievement.

17. The signal bearing medium of claim 15, wherein the instructions further comprise an operation to generate a printable version of a game.

18. The signal bearing medium of claim 15, wherein the socket comprises a folder.

19. The signal bearing medium of claim 15, wherein content modules are selected from the group consisting of data files, objects, rules, parameters, conditions, data sets, graphics, media files, audio files, and video files.

20. The signal bearing medium of claim 15, wherein a game is selected from the group consisting of “how it works” simulations, exploration games, business simulators, network marketing simulators, service-provider simulators, electronic versions of board games, instructional time-lines, word puzzles, drag and drop race games, discovery type games, jigsaw puzzles, faith-promoting games, transformational games, manufacturing games, and educational games.
